(19) United States
(12) Patent Application Publication
(10) Pub. No.: US 2016/0014995 A1
(43) Pub. Date: Jan. 21, 2016

(54) Novel Dog House

(71) Applicant: Luis Bruno, Chiefland, FL (US)

(72) Inventor: Luis Bruno, Chiefland, FL (US)

(21) Appl. No.: 14/332,480

(22) Filed: Jul. 16, 2014

(51) Int. Cl. A01K 1/03

(52) U.S. Cl. CPC A01K 1/033

(57) ABSTRACT

An pet doghouse is configured as provided as a kit that may be transported to a user for assembly on site. The dog house is an assemble of components that are easily transported in a compact and efficient form. Rigid planar panels that have substantial insulating properties are cojoined by corner connectors that provide simple assembly. The corner connectors include multiple flange elements that extend in perpendicular directions to receive and retain adjoining wall panel sections.

### BACKGROUND AND SUMMARY OF THE INVENTION

The present invention pertains to pet enclosures for outdoor use. In particular, the invention concerns animal pet “houses” that are provided as a kit that may be transported to a user for assembly on-site.

The invention provides a dog house as an assembly of components that are easily transported in a compact and efficient form. Rigid planar panels that have substantial insulating properties are cojoined by corner connectors that provide simple assembly. The corner connectors include multiple flange elements that extend in perpendicular directions to receive and retain adjoining wall panel sections.

In a kit according to the invention, multiple corner connectors and wall panels are packaged together in a compact package. The packaged elements are configured to be easily joined without the use of tools other than a user's hand.

In a preferred embodiment, the corner connectors are formed of extruded plastic such as PVC. The wall panels are formed of high density insulating material with rigid impervious outer surface layers.

### DESCRIPTION OF THE DRAWINGS

FIG. 1 is an exploded perspective view of one embodiment of the invention.

FIG. 2 is a detailed view on one portion of the construction of FIG. 1.

### DETAILS OF EMBODIMENTS OF THE INVENTION

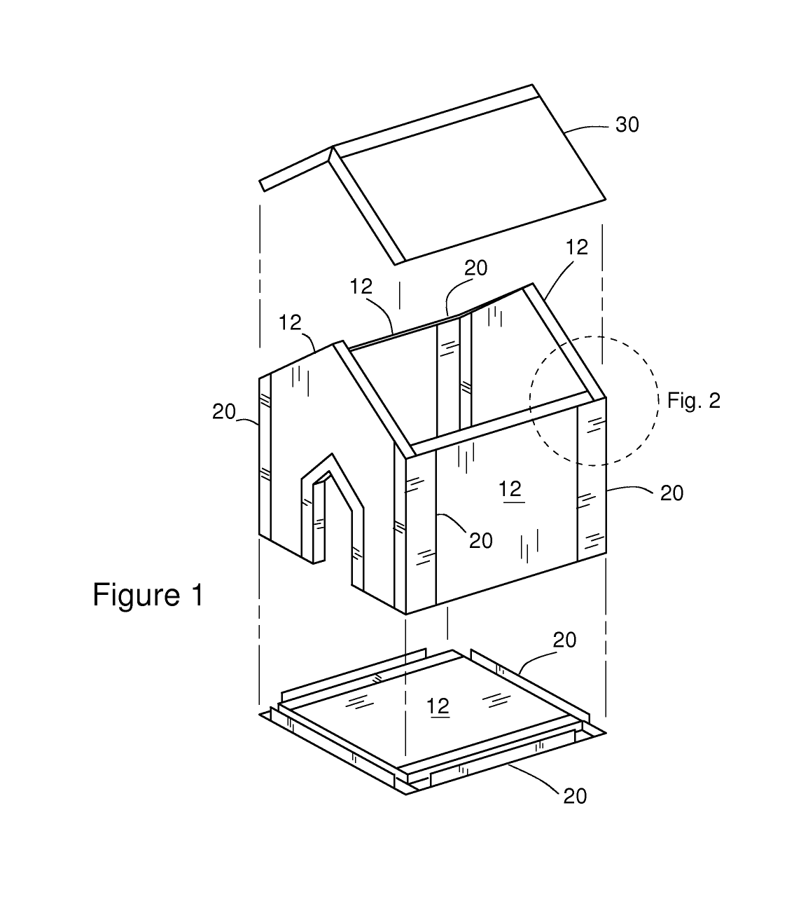

FIG. 1 illustrates one embodiment of a doghouse according to the invention. While the term “doghouse” is used here, it will be clear that use of the inventive structure is not limited to dogs enclosures, but may be used in association with other animals, or other uses appropriate for convention doghouses and like structures.

The doghouse 100 is formed of multiple rigid planar panels 12. The particular size and shape of each panel 12 may differ depending on the specific design and use. The general orientation and relative connectivity of the panels 12 is the same as in conventional doghouses in this example, but may be altered as desired while maintaining the novel aspects of the invention.

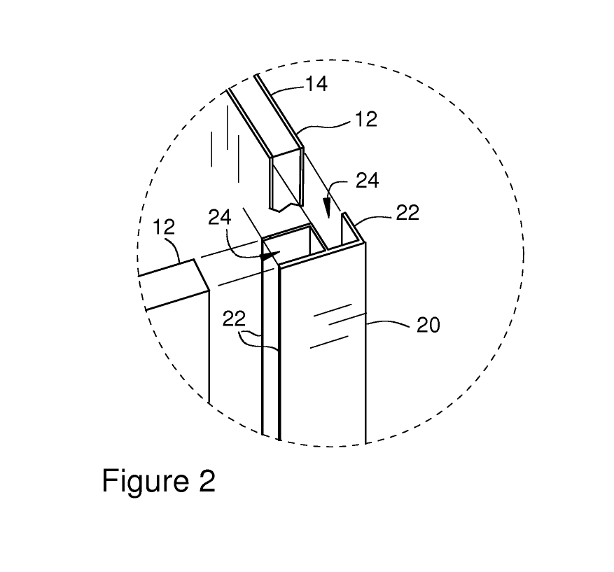

The panels 12 are joined and secured for use by corner connectors 20. The construction of the connectors 20 is illustrated in more detail in FIG. 2. Each connector 20 includes pairs of mutually parallel longitudinal flanges 22. Each connector pair is spaced apart to form a trough or slot 24 configured to receive and retain one edge of a panel 12. Each connector 12 includes two such slots 24 oriented perpendicularly to form a 90 degree corner when associated panels 12 are received in each slot 24. In FIG. 2, the panels 12 are withdrawn from the slots 24 for illustration purposes. Wherever two adjoining panels 12 meet, they may be joined by a respective connector 20. Each connector 20 in the embodiment shown has a similar construction and configuration. The length of each connector 20 is preferably equal to the full edge length of the associated panel to be secured. Will be clear that at the intersection of adjoining connectors 20, one or more of the connector length may be adjusted to prevent overall while providing full edge length support.

Each connector is preferably formed of a rigid yet resilient material while the slot is dimensioned slightly narrower than the associated panel. In this way, the panel will be securely retained by compression and friction within the slot. Extruded PVC (substantially polyvinylchloride) materials are preferred. However, other materials having similar properties may also be used.

Each panel 12 is designed and configured to provide both rigidity and insulating properties as protection from ambient conditions. Preferably, each panel 12 has a thickness in the range of about ¾ inch. The panels 12 are formed of a insulating material or construction having a high thermal resistance. Preferably, the panels 12 are formed of EPS (expanded polystyrene) foam material designed for insulation applications. The panels 12 include a rigid and impervious exterior face layer 14 on both sides. The face layer may be formed by a rigid polyurea coating applied to a thickness of 1/32 inch. This may be accomplished by using the branded Styrospray 1000 (registered trademark of Industrial Polymers Inc. of Texas, USA) coating material applied to the specified thickness. Alternatively, the face layer 14 may be formed of polyurethane applied as a spray coating at a thickness of 1/32 inch. Other alternative materials with similar properties may also be used. A color finish layer may be applied as well. The inner face layer 14 is more preferably formed of an antimicrobial fiberglass-reinforced polymer (FRP) sheeting of 1/16 inch thickness. The sheeting may be secured by adhesive to the insulating material.

One purpose and function of the face layers 14 is both to provide a durable connection with the connector flanges 22 and to provide an impervious surface resisting contact with liquids and dirt during use. Panels 12 should not attempted to be formed of materials without a rigid surface layer 14 as the necessary mode of assembly with not function as the flanges 22 will dig into and bury into the panel surface. A rigid face layer 14 surface is critical.

The roof 30 is preferably formed of the same material as the panels 12 and has the same general geometry as the panels 12. If may be desired to have a roof peak angle other than 90 degrees. Two panels elements may be joined using other, conventional, devices or methods for that purpose to form the roof 30. One alternative is to provide a second connector having flanges and slots in the appropriate angle, although this is not preferred as being unnecessarily costly.

Incidental features of the doghouse having free panel edges, such as a doorway, may be finished by using a flanged element similar in construction to the connector 20.

The design of the corner connectors 20 and panels 12 allow for manual assembly without specific tools other than the user's hands. The individual panels 12 maybe partially inserted laterally into one connector slot 24 and then slid entirely into the slot until the connector 20 is appropriately positioned longitudinally and the panel 12 is fully engaged to the bottom of the slot 24. Each panel 12 may be sequentially secured into the associated connectors until the doghouse structure is complete. While fasteners may be optionally introduced through the flanges 22 and the received panel 12 to further lock them into place, this is not necessary if the connectors 20 are properly configured.

The invention includes a kit of components (as see in FIG. 1) which are configured for simple manual assembly into a doghouse structure. While the individual components are illustrated in FIG. 1 in partially assembled form, their nature of their separate identities is made clear in FIG. 2—that is each panel 12 is separate from all associated connectors 20 when in a disassembled kit form. The design of the panels 12 and connectors 20 is such that, when disassembled, the components will stack in a compact form for easy transport. The geometry of the connectors 20 is such that one planar thickness dimension is only slightly greater than the thickness of the panels 12. This allows compact stacking with the panels 12. When assembled, each panel 12 of the walls and floor are each secured by at least three connectors 20 to form an integrated enclosure.

The above refers to particular embodiments of the invention. Other embodiments including the novel aspects will be clear from this discussion, the accompanying figures and the claims.

1. A kit doghouse comprising:
a plurality of rigid panels;
each panel comprising an insulating material having an impervious rigid surface face;
multiple connectors;
each connector having two pairs of longitudinal flanges together forming two perpendicular slots, each slot configured to receive and retain one of the panels;
such that the panels may be combined with the connectors to form a rigid enclosure.
